(19) United States
(12) Patent Application Publication
(10) Pub. No.: US 2009/0162568 A1
(43) Pub. Date: Jun. 25, 2009

(54) MANUFACTURING METHOD OF OPTICAL FILM

(75) Inventor: Yue-Shih Jeng, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: Taiwan TFT LCD Association, Hsinchu (TW); Chunghwa Picture Tubes, LTD., Taoyuan (TW); Au Optronics Corporation, Hsinchu (TW); Hannstar Display Corporation, Taipei City (TW); Chi Mei Optoelectronics Corporation, Tainan County (TW); Industrial Technology Research Institute, Hsinchu (TW); TPO Displays Corp., Miao-Li County (TW)

(21) Appl. No.: 12/396,494

(22) Filed: Mar. 3, 2009

Related U.S. Application Data
(62) Division of application No. 11/672,965, filed on Feb. 9, 2007.

(30) Foreign Application Priority Data
Dec. 1, 2006 (TW) 95144631

(51) Int. Cl. B05D 3/06; B05D 5/06

(52) U.S. Cl. 427/553; 427/162

(57) ABSTRACT

A method of manufacturing an optical film includes steps of providing a substrate first and performing an alignment treatment on the surface of the substrate or forming an alignment layer on the substrate. A first liquid crystal layer is then coated on the aligned surface of the substrate or on the surface of the alignment layer, and thereafter, a first curing step is performed. After a second alignment layer is coated on the surface of the first liquid crystal layer, a second curing step is performed so as to form a multi-layer including the first and second liquid crystal layers.

### CROSS-REFERENCE TO RELATED APPLICATION

This application is a divisional of and claims the priority benefit of an application Ser. No. 11/672,965, filed on Feb. 9, 2007, now pending, which claims the priority benefit of Taiwan application serial no. 95144631, filed on Dec. 1, 2006. The entirety of each of the above-mentioned patent applications is hereby incorporated by reference herein and made a part of this specification.

### BACKGROUND OF THE INVENTION

1. Field of the Invention

The present invention relates to an optical film, a method of manufacturing the same, and a substrate structure and a display panel using the optical film. More particularly, the present invention relates to a multi-functional optical film, a method of manufacturing the same, and a substrate structure and a display panel using the optical film.

2. Description of Related Art

Conventionally, an optical film of a display panel is usually manufactured through an adhering process. In other words, various optical films are adhered onto a substrate layer by layer through the adhesion material. Moreover, additional passivation layers are required to protect the optical films. Afterwards, the substrate having a plurality of the optical films is attached onto the display panel. In the conventional manufacturing method, the adhesion material is required by each of the optical films, and the optical films necessitate a support from the substrate and protection of the passivation layer, thus leading to high manufacturing costs of the optical films and a negative impact on the optical characteristics of the optical films. Moreover, an excessive thickness of the optical films fabricated by said method can be expected.

U.S. Pat. Nos. 6,160,597, 6,369,869 and 6,717,644 disclose a method of manufacturing the optical films through a non-adhering process. Namely, a plurality of the liquid crystal layers is utilized to form the optical film. However, said process requires an alignment layer sandwiched between every two of the liquid crystal layers so as to specifically align the liquid crystal layers. Due to the requirement of an additional alignment layer disposed between every two of the liquid crystal layers, the process of manufacturing the optical film remains complicated, and the thickness of the optical film cannot be effectively reduced.

US Publication No. 2003/0152712 is directed to a method of using a liquid crystal alignment layer in conjunction with a liquid crystal polymer layer so as to form an optical film. According to this method, one liquid crystal alignment layer is required by each of the liquid crystal layer having special optical characteristics so as to align the liquid crystal layer. Thus, the method neither simplifies the process of manufacturing the optical film nor reduces the manufacturing costs.

### SUMMARY OF THE INVENTION

The present invention provides an optical film requiring no other alignment film disposed among each of the optical films.

The present invention further provides a method of manufacturing an optical film so as to improve the conventional complicated manufacturing process and to reduce high costs.

The present invention further provides a substrate structure of a display panel, in which the optical film is directly formed on the substrate. Thus, no additional adhering process is required for adhering the optical film onto the substrate.

The present invention further provides a display panel, in which the optical film is directly formed thereon. The manufacturing process can be accordingly simplified and the cost can be reduced.

The present invention provides an optical film including a substrate, a first liquid crystal layer and a second liquid crystal layer. The substrate has an aligned surface or has an alignment layer thereon. The first liquid crystal layer is disposed on the aligned surface of the substrate or the surface of the alignment layer. The second liquid crystal layer is disposed on a surface of the first liquid crystal layer so as to form a multi-layer including the first and the second liquid crystal layers.

The present invention further provides a method of manufacturing an optical film, including the steps of providing a substrate first and performing an alignment treatment on the surface of the substrate or forming an alignment layer on the substrate. Then a first liquid crystal layer is coated on the aligned surface of the substrate or on the surface of the alignment layer, and thereafter, a first curing step is performed. After a second alignment layer is coated on the surface of the first liquid crystal layer, a second curing step is performed so as to form a multi-layer including the first and second liquid crystal layers.

The present invention further provides a substrate structure of a display panel, including a substrate, a first alignment layer, a first liquid crystal layer and a second liquid crystal layer. A device layer is already disposed on the substrate. The first alignment layer is disposed on a surface of the substrate. The first liquid crystal layer is disposed on a surface of the first alignment layer. The second liquid crystal layer is disposed on a surface of the first liquid crystal layer so as to form a multi-layer including the first and the second liquid crystal layers.

The present invention further provides a display panel, including a first substrate, a first alignment layer, a first multi-layer, a second substrate, a second alignment layer, a second multi-layer and a display medium. A first device layer is already disposed on the first substrate. The first alignment layer is disposed on a surface of the first substrate. The first multi-layer is disposed on a surface of the first alignment layer, and the first multi-layer includes at least two liquid crystal layers. The second substrate is disposed on an opposite side of the first substrate, and a second device layer is already disposed on the second substrate. The second alignment layer is disposed on a surface of the second substrate. The second multi-layer is disposed on a surface of the second alignment layer, and the second multi-layer includes at least two liquid crystal layers. The display medium is sandwiched between the first substrate and the second substrate.

In the present invention, only one alignment layer is required by the optical film for directly forming a multi-functional multi-layer on said alignment layer. Namely, no additional alignment layer is needed among each film of the multi-layer. Accordingly, the optical film of the present invention has the advantage of simplifying manufacturing process and reducing costs.

Several embodiments accompanied with figures are described in detail in the following to present the above-mentioned and other disclosures, features and advantages of the present invention.

### BRIEF DESCRIPTION OF THE DRAWINGS

FIGS. 1A through 1D are cross-sectional schemes illustrating a process of manufacturing an optical film according to one embodiment of the present invention.

FIG. 2 is a cross-sectional scheme illustrating a substrate structure of a display panel according to one embodiment of the present invention.

FIG. 3 is a cross-sectional scheme illustrating a substrate structure of a display panel according to another embodiment of the present invention.

FIGS. 4 through 7 are cross-sectional schemes illustrating a display panel according to several embodiments of the present invention.

### DESCRIPTION OF EMBODIMENTS

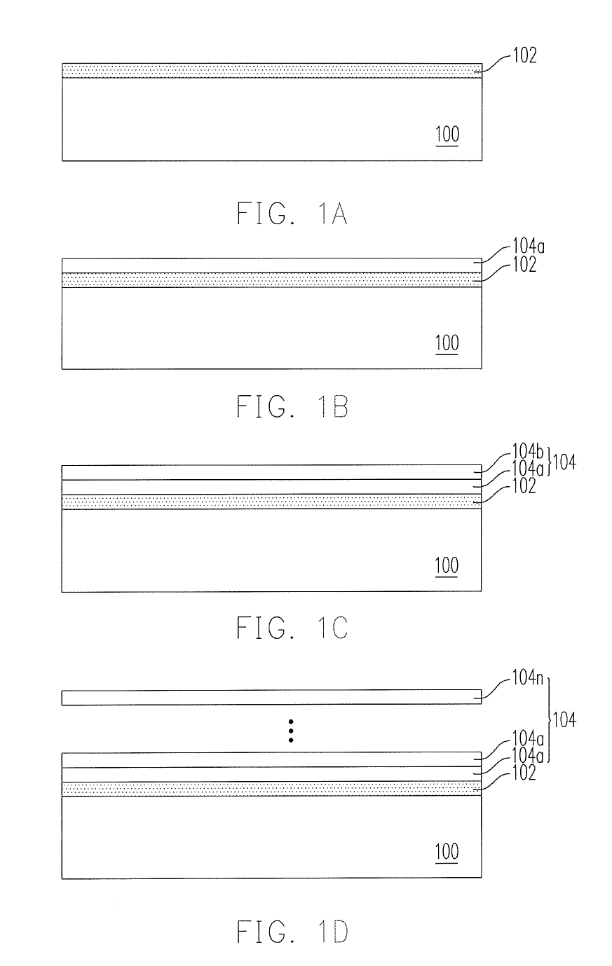

FIGS. 1A through 1D are cross-sectional schemes illustrating a process of manufacturing an optical film according to one embodiment of the present invention. Please refer to FIG. 1A. First, a substrate 100 is provided, and the substrate 100 has an alignment layer 102 configured thereon. The substrate 100 can be transparent or not, and the material thereof is, for example, glass or plastic. The material of the alignment layer 102 includes, for example, organic alignment material or inorganic alignment material. In another embodiment, if the substrate 100 is transparent, an alignment treatment can be directly performed on a surface of the substrate 100 without additionally forming the alignment layer 102.

Next, please refer to FIG. 1B. A first liquid crystal layer 104a is coated on a surface of the alignment layer 102 or on the surface of the aligned transparent substrate 100. In one embodiment of the present invention, the method of coating the first liquid crystal layer 104a includes a spin coating, a blade coating, a mayer bar/rod coating, or a slot die blade coating, for example. The material of the first liquid crystal layer 104a includes liquid crystal monomers, liquid crystal polymers, liquid crystal oligomers, or liquid crystal material including pigments. Thereafter, a curing step is performed so as to cure the coated first liquid crystal layer 104a. In one embodiment of the present invention, said curing step includes an ultraviolet curing treatment or a thermal curing treatment, for example, which is mainly determined by the material of the liquid crystal layer.

Then, please refer to FIG. 1C. A second liquid crystal layer 104b is coated on a surface of the first liquid crystal layer 104a. The coating method and the material of the second liquid crystal layer 104b are similar to those of the first liquid crystal layer 104a. Thereafter, the curing step is performed so as to cure the coated second liquid crystal layer 104b. Likewise, the curing step of the second liquid crystal layer 104b is identical or similar to that of the first liquid crystal layer 104a. A multi-layer 104 is then formed by the first and the second liquid crystal layers 104a and 104b.

One of the first liquid crystal layer 104a and the second liquid crystal layer 104b is a compensation liquid crystal layer, and the other is a polarizing liquid crystal layer. In other words, if the first liquid crystal layer 104a is a compensation liquid crystal layer, the second liquid crystal layer 104b is a polarizing liquid crystal layer. Alternatively, if the first liquid crystal layer 104a is a polarizing liquid crystal layer, the second liquid crystal layer 104b is a compensation liquid crystal layer. Moreover, according to another embodiment of the present invention, the steps of coating the first and the second liquid crystal layers 104a and 104b and the first and the second curing steps conducted after said coating are performed with a continuous process, for example, through a roll-to-roll process.

It should be noted that no additional alignment layer or adhesion layer is required between each of the liquid crystal layers 104a and 104b of the multi-layer 104; namely, the liquid crystal layers 104a and 104b are in direct contact. The functional group of the liquid crystal molecules is able to self-align. Thus, after the lower liquid crystal layer 104a is aligned by the alignment layer 102, the upper liquid crystal layer 104b is also aligned through the aligned liquid crystal layer 104a, and thereby the multi-layer 104 formed by the two liquid crystal layers 104a and 104b is a compensation and polarizing liquid crystal optical film with the same optical axis.

In said embodiments, the multi-layer 104 includes two liquid crystal layers 104a and 104b, which is not intended to limit the present invention. At least a liquid crystal layer 104n may be formed on the surface of the second liquid crystal layer 104b in the present invention. Accordingly, the multi-layer 104a includes the liquid crystal layers 104a, 104b and at least one liquid crystal layer 104n. Similarly, no additional alignment layer or adhesion layer is required between each of the liquid crystal layers 104a and 104b in the multi-layer 104. In addition, the number of the liquid crystal layers in the multi-layer 104, the material of each of the liquid crystal layers, and the arrangement of the liquid crystal layers can be determined according to the actual function (e.g. polarization, compensation, wide view angle) required by the optical film.

### The Substrate Structure of the Display Panel

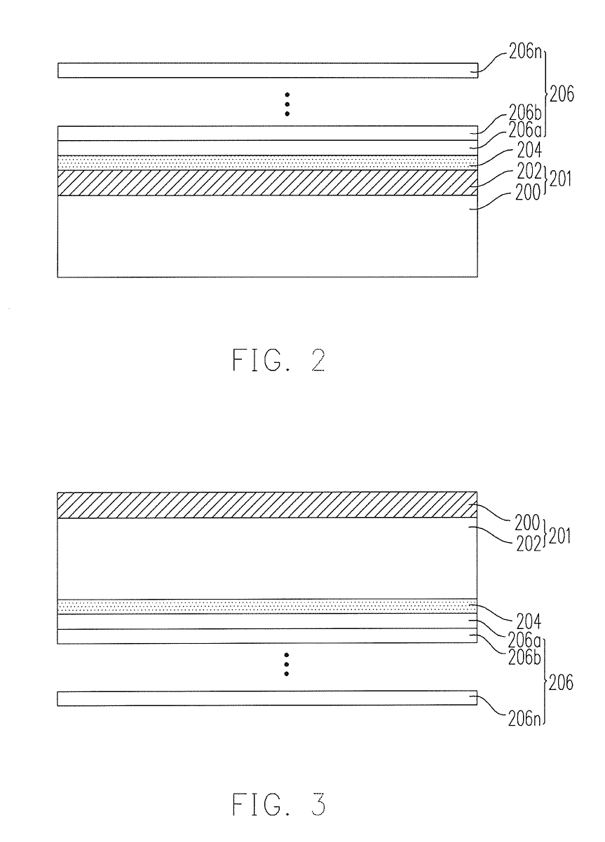

Said optical film can be directly formed on the substrate structure of the display panel, such that the substrate structure is characterized by polarization, compensation, wide view angle, and so forth. FIG. 2 is a cross-sectional scheme illustrating the substrate structure of the display panel according to one embodiment of the present invention. Please refer to FIG. 2. The substrate structure of the present embodiment includes a substrate 201, an alignment layer 204, and a multi-layer 206.

The substrate 201 includes a blank substrate 200 and a device layer 202 formed thereon. The device layer 202 is, for example, an active device array layer, a passive device layer, a color filter layer, or a common electrode layer.

In addition, the alignment layer 204 is disposed on a surface of the device layer 202, and the material of the alignment layer 204 can be an organic or an inorganic alignment material. The multi-layer 206 is disposed on a surface of the alignment layer 204. Particularly, the multi-layer 206 includes a first liquid crystal layer 206a and a second liquid crystal layer 206b. According to another embodiment, the multi-layer 206 including the liquid crystal layers 206a and 206b is capable of stacking at least one liquid crystal layer 206n on a surface of the liquid crystal layer 206b. The material and the manufacturing method of the liquid crystal layers 206a, 206b and 206n are similar to those of the liquid crystal layers provided hereinbefore, as indicated in 104a, 104b and 104n of FIGS. 1B through 1D.

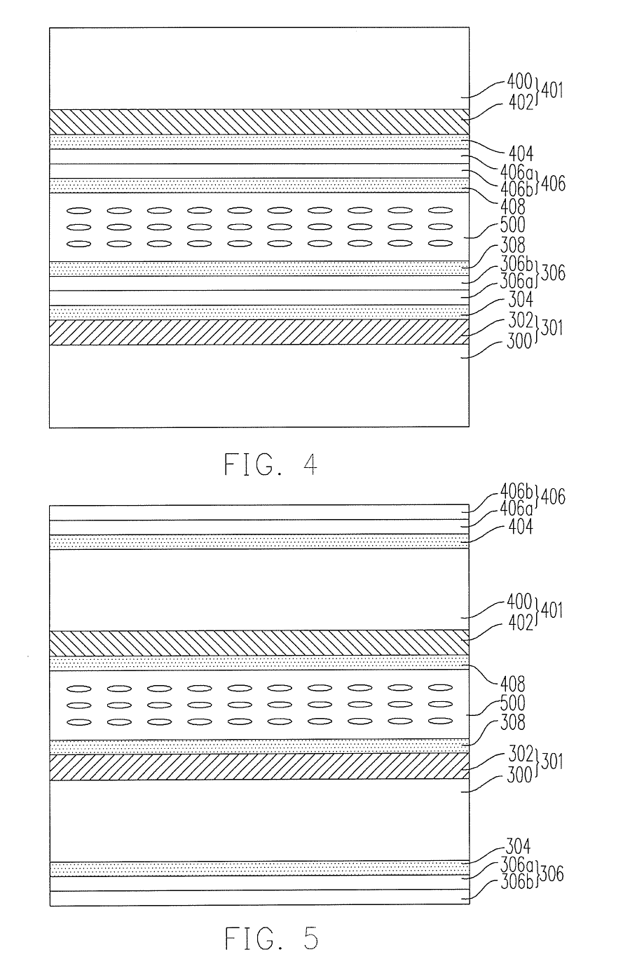

FIG. 3 is a cross-sectional scheme illustrating a substrate structure of a display panel according to another embodiment of the present invention. Please refer to FIG. 3. The substrate structure in FIG. 3 is similar to that in FIG. 2. The difference lies in that the alignment layer 204 and the multi-layer 206 are formed on another surface of the substrate 200. That is to say, the device layer 202 is formed on one surface of the substrate 200, and the alignment layer 204 and the multi-layer 206 are formed on the other.

The optical film of the present invention is formed through coating and curing, and no additional alignment layer is required between each layer of the multi-layer of the optical film. Therefore, the application of the optical film of the present invention is conducive to simplifying the process of manufacturing the substrate structure of the display panel and reducing the manufacturing costs.

In the present invention, the alignment layer and the multi-layer are directly formed on the substrate structure of the display panel, so as to simplify the manufacturing process and reduce the costs. However, the present invention is not limited to this. Alternatively, the alignment layer and the multi-layer can be firstly formed on the substrate to form the optical film in the present invention. Then, the optical film is attached to the device substrate.

### Display Panel

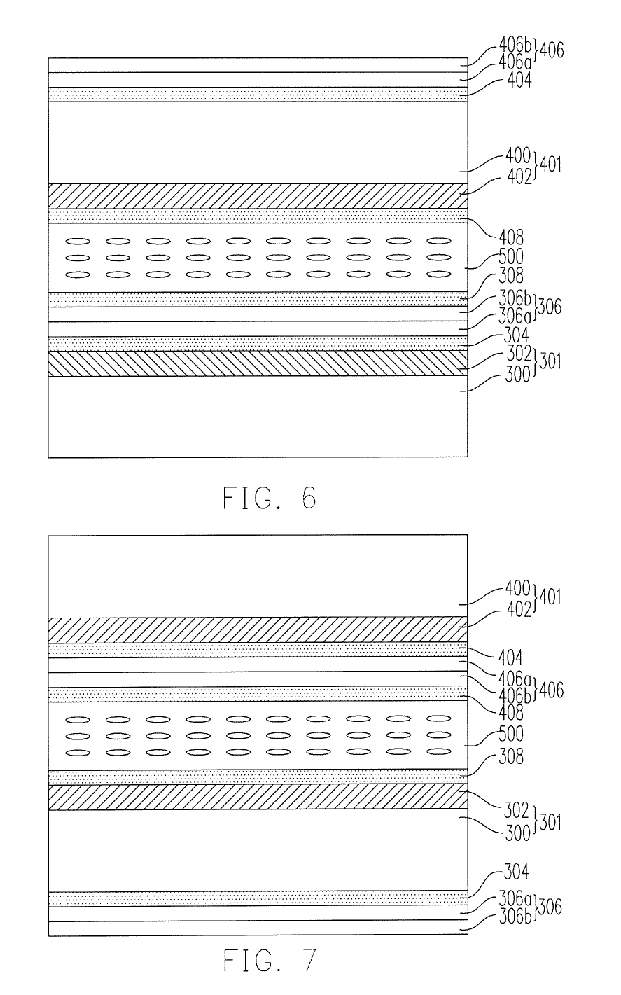

Said substrate structure can be combined with another substrate structure and a display medium to form a display panel. The detailed description is provided hereinafter. FIG. 4 is a cross-sectional scheme illustrating a display panel according to one embodiment of the present invention. Please refer to FIG. 4. The display panel disclosed in the present embodiment includes a first substrate 301, a first alignment layer 304, a first multi-layer 306, a second substrate 401, a second alignment layer 404, a second multi-layer 406 and a display medium 500.

The first substrate 301 includes a blank substrate 300 and a first device layer 302 formed thereon. The first device layer 302 is, for example, an active device array layer, a passive device layer, a color filter layer, or a common electrode layer. In detail, the first device layer 302 can be an active device array layer, a passive device layer, a color filter layer, or a common electrode layer, which is determined by the type of the display panel (e.g. an active display panel or a passive display panel).

The first alignment layer 304 is disposed on a surface of the first substrate 301. The first multi-layer 306 is disposed on a surface of the first alignment layer 304, and the first multi-layer 306 includes at least two liquid crystal layers 306a and 306b. In the present embodiment, the first multi-layer 306 including two liquid crystal layers 306a and 306b is taken for an example, while the number of the liquid crystal layers included in the first multi-layer 306 is not limited in the present invention. The material and the manufacturing method of the liquid crystal layers 306a and 306b are similar to those of the liquid crystal layers provided hereinbefore, as indicated in 104a, 104b and 104n of FIGS. 1B through 1D. Thus, further illustration is omitted.

The second substrate 401 is disposed on an opposite side of the first substrate 301, and the second substrate 401 includes a blank substrate 400 and a second device layer 402 formed thereon. Determined by the type of the display panel and the corresponding first device layer 302, the second device layer 402 can be an active device array layer, a passive device layer, a color filter layer, or a common electrode layer. For example, if the display panel is an active display panel and the first device layer 302 is an active device array layer, the second device layer 402 is a color filter array layer, a common electrode layer, or a combination thereof. If the display panel is a passive display panel and the first device layer 302 is a passive device layer, the second device layer 402 is another passive device layer, a color filter array layer, or a combination thereof.

The second alignment layer 404 is disposed on a surface of the second substrate 401. The second multi-layer 406 is disposed on a surface of the second alignment layer 404 and includes at least two liquid crystal layers 406a and 406b. Likewise, in the present embodiment, the second multi-layer 406 including two liquid crystal layers 406a and 306b is taken for an example, while the number of the liquid crystal layers included in the second multi-layer 406 is not limited in the present invention. The material and the manufacturing method of the liquid crystal layers 406a and 406b are similar to those of the liquid crystal layers provided hereinbefore, as indicated in 104a, 104b and 104n of FIGS. 1B through 1D. Thus, further illustration is omitted.

Furthermore, the display medium 500 is sandwiched between the first substrate 301 and the second substrate 401. The display medium 500 is liquid crystals, for example. If the liquid crystals are used as the display medium 500, the display panel is a liquid crystal display panel.

Given that the alignment layer is required by the display panel for aligning the display medium, the display panel can further include a third alignment layer 308 and a fourth alignment layer 408. The third alignment layer 308 is disposed on the first multi-layer 306, and the fourth alignment layer 408 is disposed on the second multi-layer 406. The display medium 500 is sandwiched between the third and the fourth alignment layers 308 and 408. The third and the fourth alignment layers 308 and 408 are mainly utilized to align the display medium 500, such that the display medium 500 possesses a certain pre-tilt angle.

There are other ways to arrange the third alignment layer 308, the fourth alignment layer 408, and other film layers of the display panel. Please refer to FIG. 5. The first alignment layer 304 and the first multi-layer 306 are disposed on one surface of the first substrate 301, while the third alignment layer 308 is disposed on the other. Likewise, the second alignment layer 404 and the second multi-layer 406 are disposed on one surface of the second substrate 401, and the fourth alignment layer 408 is disposed on the other. Here, the display medium 500 is sandwiched between the third and the fourth alignment layers 308 and 408, so as to align the display medium 500.

Moreover, in another embodiment of the present invention, the arrangement of the third alignment layer 308, the fourth alignment layer 408, and other film layers of the display panel is shown in FIG. 6. The third alignment layer 308 is disposed on the first multi-layer 306, and the fourth alignment layer 408 is disposed on the surface of the second substrate 401 without the disposition of the second alignment layer 404 and the second multi-layer 406 on said surface. Here, the display medium 500 is sandwiched between the third and the fourth alignment layers 308 and 408, so as to align the display medium 500.

In addition, in another embodiment of the present invention, the arrangement of the third alignment layer 308, the fourth alignment layer 408, and other film layers of the display panel is shown in FIG. 7. The third alignment layer 308 is disposed on the surface of the first substrate 301 without the disposition of the first alignment layer 304 and the first multi-layer 306 on said surface, and the fourth alignment layer 408 is disposed on the second multi-layer 406. Here, the display medium 500 is sandwiched between the third and the fourth alignment layers 308 and 408, so as to align the display medium 500.

In the display panel of the present invention, the multi-layer including a plurality of the liquid crystal layers is functioned as the polarizing film or the compensation film. The film layers can be coated on the substrate directly, and no additional alignment layer or adhesion layer is required between every two of the liquid crystal layers in the multi-layer. Accordingly, the display panel of the present invention has the advantages of low costs and simplified manufacturing process.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method of manufacturing an optical film, comprising:
providing a substrate;
performing an alignment treatment on a surface of the substrate or forming an alignment layer on the substrate;
coating a first liquid crystal layer on the aligned surface or on a surface of the alignment layer;
performing a first curing step;
coating a second liquid crystal layer on a surface of the first liquid crystal layer; and
performing a second curing step so as to form a multi-layer including the first and the second liquid crystal layers.

2. The method of claim 1, wherein the first and the second curing steps comprise an ultraviolet curing treatment or a thermal curing treatment, respectively.

3. The method of claim 1, wherein the method of coating the first and the second liquid crystal layers comprises a spin coating, a blade coating, a mayer bar/rod coating, or a slot die blade coating.

4. The method of claim 1, wherein the steps of coating the first and the second liquid crystal layers and the first and the second curing steps are performed with a continuous process.
